(19) United States
(12) Patent Application Publication
(10) Pub. No.: US 2012/0266542 A1
(43) Pub. Date: Oct. 25, 2012

(54) Latch assembly for a door

(76) Inventors: Stanley Szprengiel, Jackson, NJ (US); Thomas Graham, Ocean, NJ (US)

(21) Appl. No.: 13/066,767

(22) Filed: Apr. 25, 2011

(51) Int. Cl. E06B 3/70; E05B 9/00

(52) U.S. Cl. 49/503; 292/337

(57) ABSTRACT

The latch assembly employs a coil spring for biasing a roller assembly with a main roller in a direction outwardly of the housing. The roller assembly has a pair of guide rollers or guide plates for guiding the roller assembly on the inside of the housing during use. The coil spring is positioned between the two guide rollers and remains coaxial of the housing during pivoting of the roller assembly within the housing during use. Guide pins are provided to keep the roller assembly from rubbing against the housing walls as a thrust load is applied to the main roller.

This invention relates to a latch assembly for a door. More particularly, this invention relates to a latch assembly for a door of an oven.

As is known, various doors have been provided with latch assemblies in order to hold the doors in a closed position. For example, a latch assembly sold by Component Hardware Group, Inc. under Model No. M23-5000 has been known for use in heated applications, such as for warmers and ovens, to secure a door in a closed position. This latch assembly employs a two roller construction which is movably mounted in a housing fixed within the door to engage with a strike secured to a frame against which the door is to be closed. In addition, a coil spring is disposed in the housing in order to bias the two roller construction outwardly and to allow the construction to roll over the strike into a locking position.

In situations where the door of a warmer or oven does not permit the housing of a latch assembly to be accommodated, there is a need for a shorter assembly. However, simply providing a shorter housing with a shorter coil spring, reduces the spring force.

Accordingly, it is an object of the invention to provide a latch assembly of relatively shorter length than the known latch assembly and with a coil spring of equal strength.

It is another object of the invention to provide a latch assembly with a coil spring of equal strength to the known latch assembly without resorting to exotic, expensive materials and processes.

It is another object of the invention to provide a latch assembly of relatively simple construction.

Briefly, the invention provides a latch assembly comprised of a housing, a roller assembly and a coil spring.

The latch assembly is sized to be mounted within a door, for example, the door of a heating appliance, such as an oven. Generally, the housing of the latch assembly is sized to be fitted within an elongated recess in the door while the roller assembly projects from a forward end of the housing.

The housing of the latch assembly has a bore of rectangular cross-section to receive the roller assembly, a closed end at one end of the bore on which the coil spring is seated and an open end at the opposite end of the bore through which the roller assembly projects under the bias of the coil spring.

The roller assembly is movably mounted in the bore of the housing and is biased by the coil spring in a direction outwardly of the housing in order to engage with and move over a strike mounted on a door frame. The roller assembly has a main roller that is rotatably mounted at one end of the assembly to project from the housing as well as a guide means in the form of a pair of guide rollers rotatably mounted at an opposite end of the assembly on a common axis. Alternatively, guide plates may be used as the guide means instead of the guide rollers.

The coil spring is mounted between the closed end of the housing and the roller assembly for biasing the roller assembly longitudinally outwardly of the housing as well as being disposed between the pair of guide rollers of the roller assembly.

In use, with the latch assembly mounted within or on a door, as the door moves from an opened position towards a closed position on a door frame determined by a strike on the door frame, the projecting roller of the roller assembly initially abuts the strike and causes the roller assembly to pivot within the housing while also causing the roller assembly to be depressed into the housing against the force of the coil spring. After passage of the roller over the strike, the roller is biased by the coil spring outwardly of the housing to a closed position behind the strike.

During pivoting of the roller assembly within the housing under the application of a thrust load on the projecting roller, the two guide rollers engage and roll on the sidewalls of the housing thereby facilitating movement of the roller assembly on the interior of the housing.

In addition, a pair of guide pins is provided in the housing to further keep the roller assembly from rubbing against the housing walls as the thrust load is applied to the upper roller. Also, a spring locator is disposed against the closed end of the housing to keep the coil spring from rubbing on the lower rollers of the roller assembly or moving out of the center of the housing.

During use, the two pins restrain the roller assembly and act as a pivot and sliding point for the roller assembly as the force is applied to the upper roller at a right angle. Then, as the assembly descends into the housing, the two thinner lower rollers of the roller assembly contact the inside of the housing and roll thereon as the assembly descends into the housing. At the same time, the spring locator holds the spring centered in the housing so that the spring does not shift and drag along the housing inner wall causing unwanted friction.

During opening of the door from the door frame, under a manually applied force, the roller assembly pivots in a reverse manner as the roller assembly is depressed into the housing against the force of the coil spring.

The placement of the coil spring between the pair of guide rollers of the roller assembly allows the coil spring to be of the same length as the coil spring of known latch assemblies while the length of the housing is reduced as compared to the known latch assembly.

These and other objects and advantages of the invention will become more apparent from the following detailed description taken in conjunction with the accompanying drawings wherein:

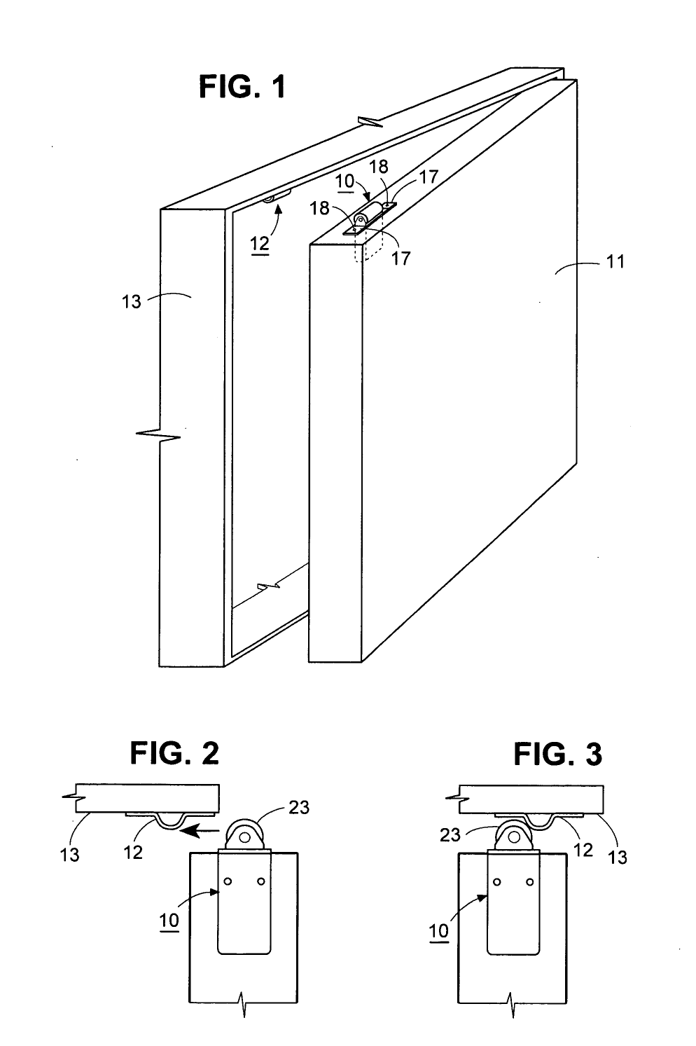

FIG. 1 illustrates a perspective view of a door hingedly mounted on a door frame and employing a latch assembly in accordance with the invention;

FIG. 2 schematically illustrates the position of the latch assembly of FIG. 1 relative to a strike during closing of the door of FIG. 1;

FIG. 3 illustrates a position of the latch assembly of FIG. 1 in a closed position;

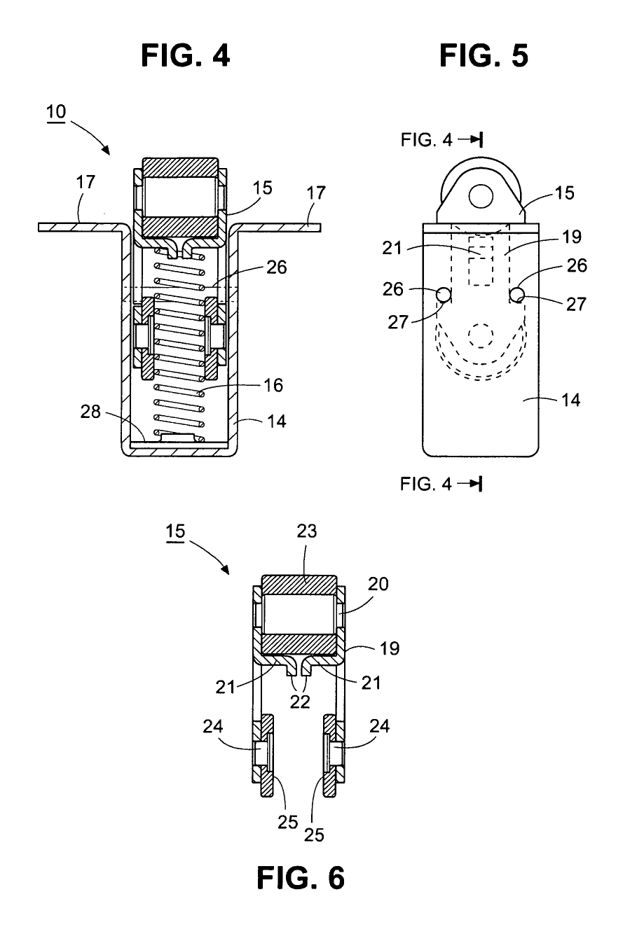

FIG. 4 illustrates a cross-sectional view of the latch assembly of FIG. 1 in accordance with the invention;

FIG. 5 illustrates a side view of the latch assembly of FIG. 4;

FIG. 6 illustrates a cross sectional view of a roller assembly of the latch assembly;

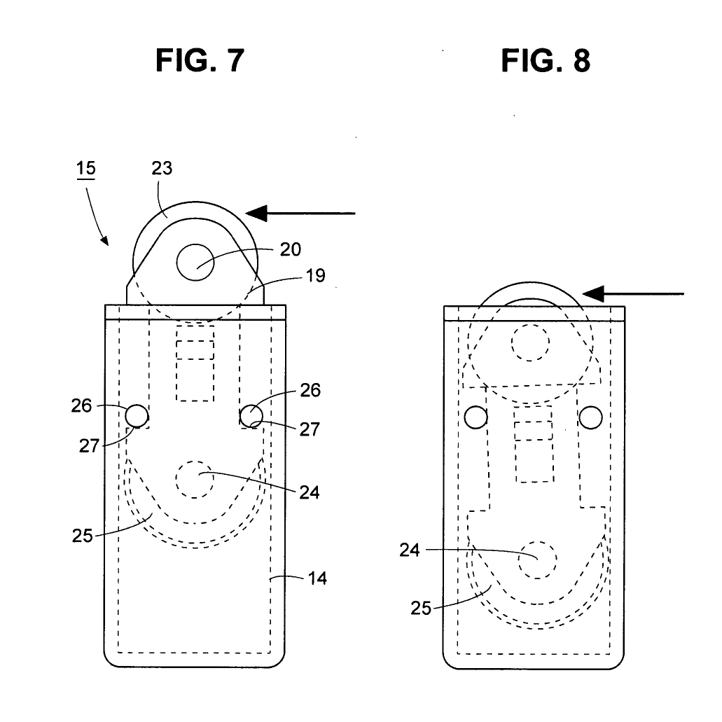

FIG. 7 illustrates a side view of the latch assembly of FIG. 1 under a thrust load;

FIG. 8 illustrates the manner of pivoting of the roller assembly of the latch assembly under a thrust load in accordance with the invention;

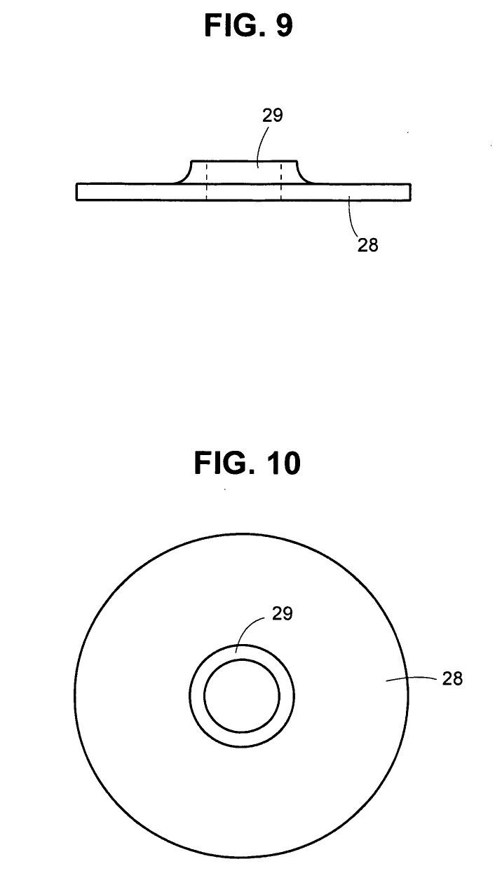

FIG. 9 illustrates a side view of a spring locator in accordance with the invention; and

FIG. 10 illustrates a plan view of the spring locator of FIG. 9.

Referring to FIG. 1, the latch assembly 10 is constructed to be mounted within or on a door 11, for example, a door of a heating appliance, for cooperation with a strike 12 mounted on a door frame 13. As illustrated in FIG. 1, the latch assembly 10 is mounted in the top of the door 11. However, the latch assembly 10 may also be mounted in a side wall of the door 11, in which case, the latch assembly 10 would be disposed horizontally rather than vertically. The strike 12 would be mounted on the side wall of the door frame 13.

Referring to FIGS. 4 and 5, the latch assembly 10 is comprised of a housing 14, a roller assembly 15 and a coil spring 16.

The housing 14 has a bore of rectangular cross section to receive the roller assembly 15 and coil spring 16. As illustrated, the housing 14 is provided with a pair of flanges 17 that are sized and positioned to engage against the door 11 (see FIG. 1). Each flange 17 may be provided with an aperture 18 (see FIG. 1) to permit securement of the housing 14, as by screws, or the like, to the door 11.

As illustrated in FIG. 4, the housing 14 has a closed end on which the coil spring 16 is seated and an opposite open end from which the roller assembly 15 projects under the bias of the coil spring 16.

Referring to FIG. 6, the roller assembly 15 has a pair of parallel plates 19 and a pin 20 which is secured to and which extends between the two plates 19. The pin 20 is welded to the two plates 19 and serves to hold the plates 19 in fixed relation with respect to each other.

Each plate 19 is provided with a cutout 21 below the pin 20, as viewed, that is inwardly bent to provide a tang 22 at the free end for purposes as described below.

In addition, a main roller 23 is concentrically mounted on and about the pin 20 for rotation about the pin 20.

Each plate 19 also has a stub pin 24 secured, as by welding, at a lower end, as viewed, in an inwardly facing manner on a common axis and each stub pin 24 has a guide roller 25 concentrically and rotatably mounted thereon. As illustrated, the guide rollers 25 are disposed to rotate about a common axis.

Referring to FIGS. 4 and 5, the roller assembly 15 has a cross-sectional shape that is smaller than the bore of the housing 14 in order to allow the roller assembly 15 to tilt relative to the bore (see FIG. 8) in response to a transverse loading being imposed on the main roller 23 and to rollably engage the guide rollers 25 with the interior walls of the housing 14 within the bore.

Referring FIGS. 4 and 5, the housing 14 is also provided with a pair of guide pins 26 that are disposed transversely in and of the housing for guiding the roller assembly 15 within the housing 14. Also, each plate 19 of the roller assembly 15 is provided with a pair of shoulders 27 for abutting the pins 26 in an extended position (FIG. 5) of the coil spring 16.

Referring to FIG. 4, a spring locator 28 is disposed on the closed end of the housing 14 in order to receive the coil spring 16 in centered relation thereon. As illustrated in FIGS. 9 and 10, the spring locator 28 is in the form of a circular disc having an upraised central portion 29 that is of a diameter to fit within the diameter of the coil spring 16 for centering of the coil spring thereon.

Referring to FIG. 4, the coil spring 16 is mounted at one end on the upraised central portion of the spring locator 28 and at the other end is fitted about the two tangs 22 of the cutouts 21 of the plates 19 of the roller assembly 15 coaxial of the longitudinal axis of the housing 14 for biasing the roller assembly 15 longitudinally outwardly of the housing 14. In addition, the coil spring 16 is disposed between the pair guide rollers 25 of the roller assembly 15.

Referring to FIGS. 4 and 7, the roller assembly 15 is constructed so that in the extended position of the coil spring 16, the main roller 23 of the roller assembly 15 projects outwardly beyond the housing 14. At this time, the shoulders 27 of the plates 19 of the roller assembly 15 abut the pins 26.

Referring to FIGS. 7 and 8, upon the application of a thrust load on the main roller 23, e.g. perpendicularly of a longitudinal axis of the roller assembly 15 and housing 14, the roller assembly 15 is depressed into the housing 14 while compressing the spring 16. At the same time, the roller assembly 15 is tilted. At this time, the lower guide rollers 25 roll on the interior walls of the housing 14 thereby preventing scratching of the interior of the housing 14 by the plates 19 of the roller assembly 15. At the same time, the guide pins 26 further keep the roller assembly 15 from rubbing against the housing walls.

During this time, the coil spring 16 is compressed between the roller assembly 15 and the spring locator 28 while remaining coaxial of the longitudinal axis of the housing 14.

During movement of the roller assembly 15 and tilting of the roller assembly 15 relative to the housing 14, the spring 16 remains centered and does not shift. Further, the spring 16 does not drag along the housing walls and is spaced within the confines of the space between the two guide rollers 25.

Referring FIGS. 1 to 3, as the door 11 moves from an open position, as viewed, towards a closed position on the door frame 13 as determined by the strike 12, the projecting main roller 23 of the roller assembly 15 initially abuts the strike 12 and causes the roller assembly 15 to pivot within the housing 14 while also causing the roller assembly 15 to be depressed into the housing 14 against the force of the coil spring 16. After passage of the roller 23 over the strike 12 (FIG. 3), the roller 23 is biased by the coil spring 16 outwardly of the housing 14 to a closed position behind the strike 12.

During opening of the door 11 from the door frame 13, for example, under a manually applied force, the roller assembly 15 pivots in a reverse manner within the housing 14 and the main roller 23 rolls over the strike 12 to allow the door 11 to be moved to an open position.

The invention thus provides a latch assembly which can be fabricated with a shorter length than known latch assemblies while using the same length of coil spring.

The invention further provides a latch assembly of relatively simple construction that employs a spring biased roller assembly.

What is claimed is:

1. A latch assembly comprising
a housing having a bore of rectangular cross-section, a closed end at one end of said bore and an open end at an opposite end of said bore;
a roller assembly movably mounted in said bore of said housing, said assembly having a main roller rotatably mounted at one end thereof and projecting from said housing, and guide means at an opposite end thereof on a common axis; and
a coil spring mounted between said closed end of said housing and said roller for biasing said roller assembly longitudinally outwardly of said housing, said coil spring being disposed between said pair of guide rollers.

2. A latch as set forth in claim 1 further comprising a spring locator adjacent said closed end of said housing and receiving said coil spring in centered relation thereon.

3. A latch as set forth in claim 1 further comprising a pair of guide pins disposed transversely in and of said housing for guiding said roller assembly within said housing.

4. A latch as set forth in claim 3 wherein said roller assembly has at least one pair of shoulders for abutting said pins in an extended position of said coil spring.

5. A latch as set forth in claim 1 said roller assembly has a spring locator for receiving said coil spring in centered relation.

6. A latch as set forth in claim 1 wherein said roller assembly includes a pair of parallel plates and a pin secured to and extending between said plates, said main roller being concentrically mounted on said pin for rotation about said pin.

7. A latch as set forth in claim 6 wherein said roller assembly further includes a pair of stub pins and a pair of guide rollers, each said stub pin being secured to a respective one of said plates and having a respective one of said guide rollers concentrically and rotatably mounted thereon.

8. A latch as set forth in claim 1 wherein said guide means includes a pair of guide rollers rotatably mounted at an opposite end of said assembly.

9. A latch as set forth in claim 1 wherein said roller assembly has a cross-section shape smaller than said bore of said housing to allow said roller assembly to tilt relative to said bore in response a transverse loading being imposed on said main roller and to rollably engage said guide rollers with said housing within said bore.

10. In combination,
a door fame;
a door movably mounted relative to said door frame to move between a closed position and an open position relative to said frame;
a strike mounted on said door frame; and
a latch assembly mounted on said door, said latch assembly including a housing, a roller assembly mounted in said housing and having a main roller rotatably mounted at one end thereof and projecting from said housing to engage said strike in said closed position of said door and guide means mounted at an opposite end thereof, and a coil spring disposed between said pair of guide rollers and biasing said roller assembly longitudinally outwardly of said housing.

11. The combination as set forth in claim 10 wherein said roller assembly has a cross-section shape smaller than a bore of said housing to allow said roller assembly to tilt relative to said bore in response a transverse loading being imposed on said main roller and to engage said guide means with said housing within said bore.

12. The combination as set forth in claim 10 wherein said door has a recess receiving said housing and said housing has a pair of flanges at one end thereof abutting said door.
